(19) United States
(12) Patent Application Publication
(10) Pub. No.: US 2010/0000140 A1
(43) Pub. Date: Jan. 7, 2010

(54) Fish handling pliers

(75) Inventor: Teng Wen Nien, Taichung (TW)

Correspondence Address: CHARLES E. BAXLEY, ESQUIRE, 90 JOHN STREET, SUITE 309, NEW YORK, NY, 10038, US

(73) Assignee: Yu Wei CHANG

(21) Appl. No.: 12/217,082

(22) Filed: Jul. 1, 2008

(51) Int. Cl. A01K 97/00; B25B 7/14

(52) U.S. Cl. 43/4; 81/367; 43/53.5; 7/106

(57) ABSTRACT

A fish handling pliers includes two levers pivotally coupled together, and each has a jaw member at one end and a handle member at the other end, a protrusion is extended from one of the levers and has a lock notch, the other lever includes a channel for pivotally receiving a latch device which includes a catch for engaging with the lock notch of the other lever and for latching the levers together, and a spring biasing device for biasing the catch of the latch device to engage with the lock notch of the protrusion, or for disengaging the catch of the latch device from the protrusion, and for allowing the user to easily handle or operate the fish handling pliers.

### BACKGROUND OF THE INVENTION

1. Field of the Invention

The present invention relates to a fish handling pliers, and more particularly to a fish handling pliers including a positioning device for anchoring or positioning two levers together or for biasing the levers away from each other.

2. Description of the Prior Art

A variety of typical fish handling pliers are known in the art and comprise an upper member and a lower member pivotally coupled together, and a lower handle section pivotally coupled to the lower member, and a toggle lever extended between an upper handle section of the upper member and the lower handle section with a pivot axle.

For example, U.S. Pat. No. 6,256,923 to Norton discloses one of the typical fish handling pliers comprising an upper member and a lower member pivotally coupled together, and each including an inwardly turned jaw at their respective forward terminal ends for engaging with the fish or for engaging with and for clamping the fish hooks to the fish lines.

However, when engaging with or clamping the fish or the fish hook, the user has to use one hand to hold the fish or the fish hook, and the other hand to hold and grasp the upper and lower members together, such that the user will be busy. The typical fish handling pliers has no positioning device for anchoring or positioning the upper and lower members together when the inwardly turned jaws of the upper and lower members are engaged with the fish or the fish hook.

The present invention has arisen to mitigate and/or obviate the afore-described disadvantages of the conventional fish handling pliers.

### SUMMARY OF THE INVENTION

The primary objective of the present invention is to provide a fish handling pliers including a latch or positioning device for anchoring or positioning two levers together or for biasing the levers away from each other.

In accordance with one aspect of the invention, there is provided a fish handling pliers comprising a first lever and a second lever including a middle portion pivotally coupled together with a pivot axle, and each including a jaw member at one end thereof, and each including a handle member at the other end thereof, the first lever including a protrusion extended from the middle portion of the first lever, and the protrusion including a lock notch formed in the protrusion, and the second lever including a channel formed in the middle portion of the second lever, a latch device engaged through the channel of the second lever and pivotally coupled to the second lever with a pivot shaft for allowing the latch device to be pivoted relative to the second lever, and the latch device including a knob provided on top thereof, and including a catch provided thereon for engaging with the lock notch of the second lever and for latching the first and the second levers together, and a spring biasing device for biasing the latch device to pivot relative to the second lever and for forcing the catch of the latch device to engage with the lock notch of the protrusion of the first lever, or for disengaging the catch of the latch device from the protrusion of the first lever, and for allowing the user to easily handle and actuate or operate the fish handling pliers.

The first lever includes at least one second lock notch formed in the protrusion for selectively engaging with the catch of the latch device.

The second lever includes a cavity formed therein, and the spring biasing device includes a spring member engaged in the cavity of the second lever and engaged with either the front or the rear portion of the knob of the latch device for biasing or forcing the catch of the latch device to move relative to the lock notch of the protrusion of the first lever.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a fish handling pliers in accordance with the present invention;

FIG. 2 is a plan schematic view of the fish handling pliers;

FIG. 3 is a partial exploded view of the fish handling pliers;

FIG. 4 is an enlarged partial perspective view of the fish handling pliers;

FIG. 5 is an enlarged partial exploded view of the fish handling pliers as shown in FIG. 4;

FIG. 6 is an enlarged partial cross sectional view of the fish handling pliers taken along lines 6-6 of FIG. 1; and

FIGS. 7 and 8 are enlarged partial cross sectional views similar to FIG. 6, illustrating the operation of the fish handling pliers.

### DETAILED DESCRIPTION OF THE PREFERRED EMBODIMENT

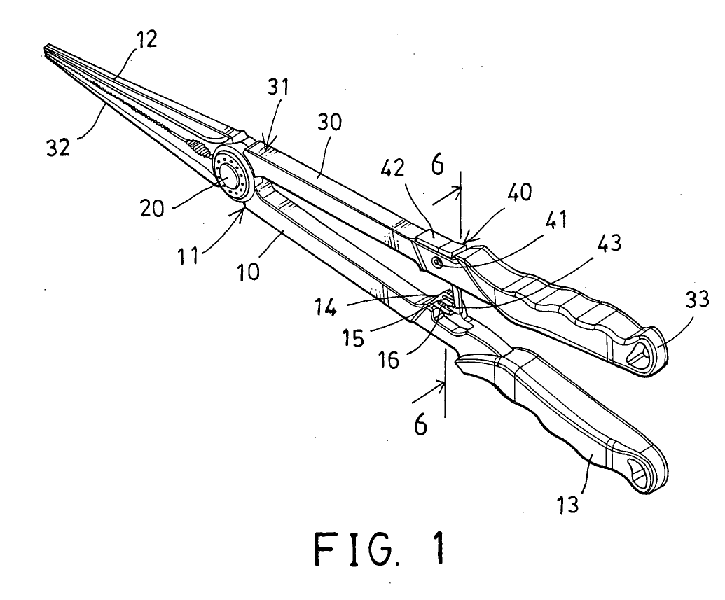

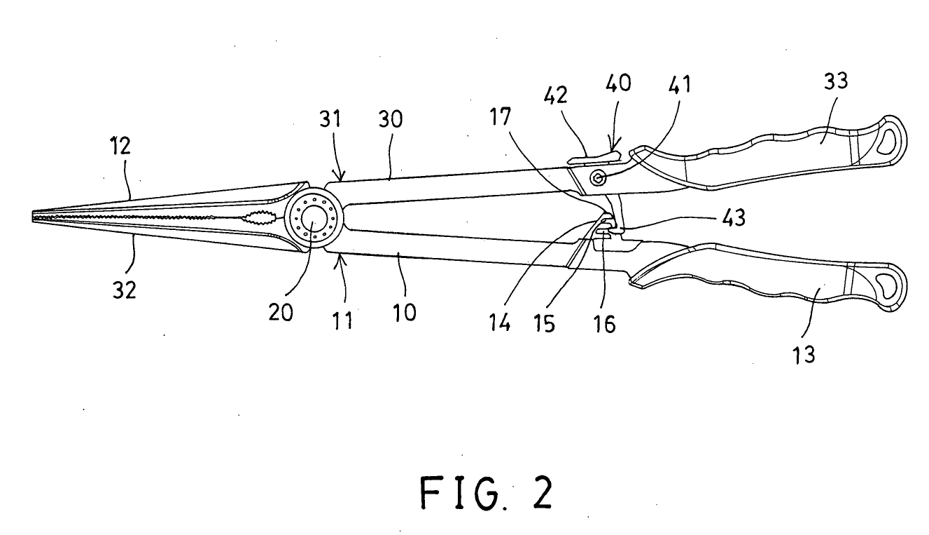

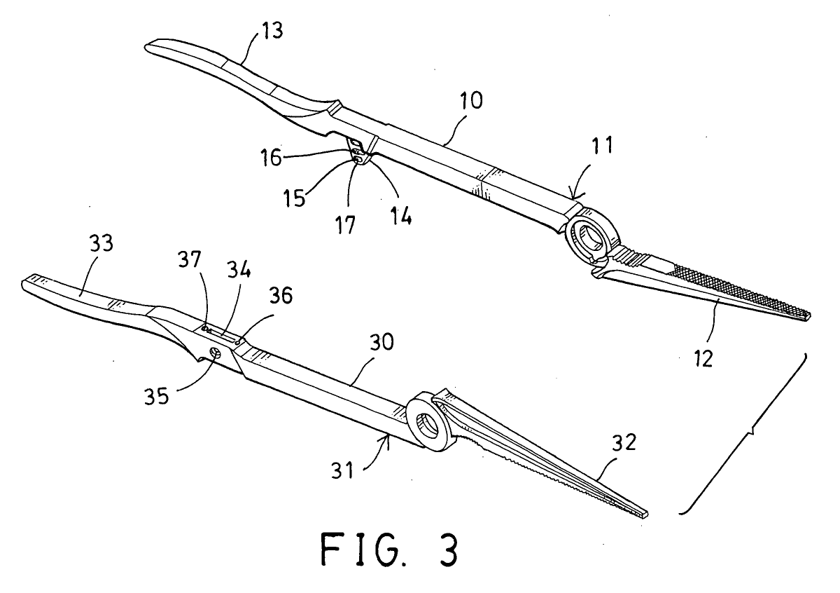

Referring to the drawings, and initially to FIGS. 1-3, a fish handling pliers in accordance with the present invention comprises two levers 10, 30 each including a middle portion 11, 31 pivotally coupled together with a pivot axle 20, and each including a jaw member 12, 32 at one end thereof for engaging with the fish or the fish hooks (not shown), and each including a handle member 13, 33 at the other end thereof for being held or grasped by the users. The above-described structure is typical and will not be described in further details.

As shown in FIGS. 1-3 and 6-8, one of the levers 10 includes a protrusion 14 extended therefrom, such as extended from the middle portion of the lever 10 and extended toward the other lever 30, and the protrusion 14 includes one or more (such as two) lock notches 15, 16 formed therein and formed or defined by two or more projections or extensions 17, it is preferable but not necessary that the lock notches 15, 16 are opened rearwardly toward the handle member 13.

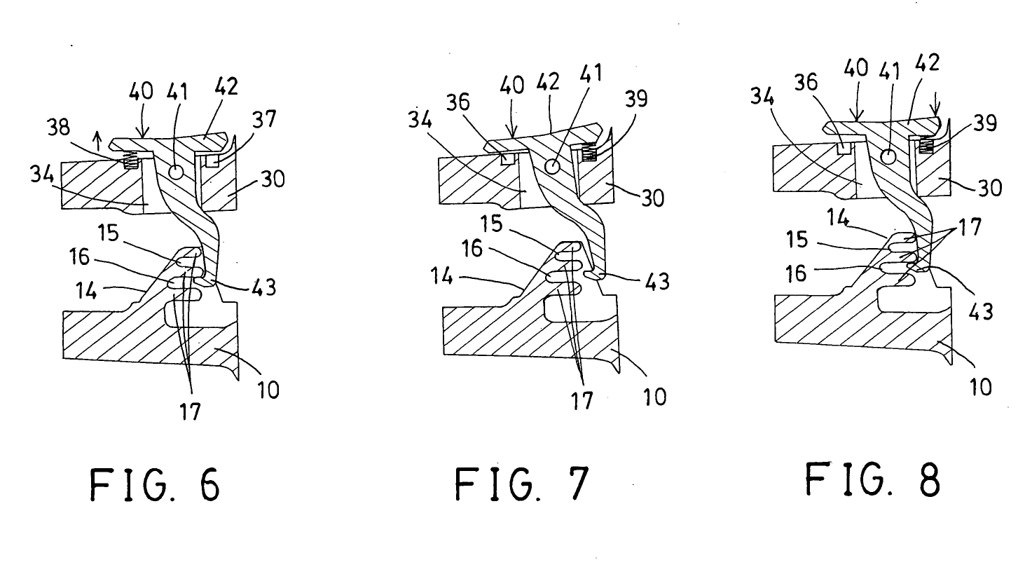

The other lever 30 includes a channel 34 formed through the middle portion 31 of the lever 30 and opened downwardly toward the protrusion 14 of the handle member 13, and includes an orifice 35 laterally formed through the lever 30 and intersecting or communicating with the channel 34 of the lever 30, and includes one or more (such as two) cavities 36, 37 formed in the upper portion thereof and opened upwardly away from the lever 10, and located in front of the channel 34 and behind the channel 34 of the lever 30 respectively for receiving spring biasing means or members 38 (FIGS. 5, 6), 39 (FIGS. 7-8) respectively.

A hook or latch device 40 is movably engaged through the channel 34 of the lever 30, and pivotally coupled to the lever 30 with a fastener or pivot shaft 41 for allowing the latch device 40 to be rotated or pivoted relative to the lever 30, and includes a hand grip or knob 42 formed or provided on top thereof for being engaged with the fingers of the user and for pivoting the latch device 40 relative to the lever 30, and for being engaged with the spring members 38, 39 respectively, and includes a hook member or catch 43 formed or provided on the lower portion thereof for engaging with either of the lock notches 15, 16 of the protrusion 14 of the lever 10 and for latching or anchoring the levers 10, 30 together.

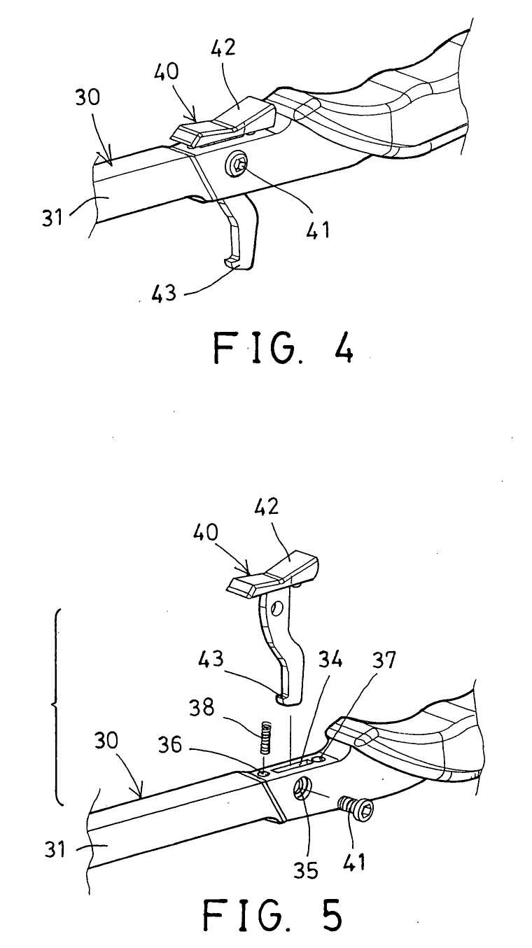

In operation, as shown in FIGS. 1-2 and 4-6, when the spring member 38 is engaged in the cavity 36 that is located in front of the channel 34 of the lever 30, the spring member 38 may be engaged with the front portion of the knob 42 and may force the latch device 40 to rotate or to pivot clockwise relative to the lever 30 (FIG. 6), and thus may force the catch 43 of the latch device 40 to engage with either of the lock notches 15, 16 of the protrusion 14 of the lever 10, and thus to selectively latch or anchor the levers 10, 30 together, and thus for allowing the user to free from depressing the knob 42 continuously.

As shown in FIGS. 7 and 8, when the other spring member 39 is engaged in the other cavity 37 that is located behind the channel 34 of the lever 30, the spring member 39 may be engaged with the rear portion of the knob 42 and may force the latch device 40 to rotate or to pivot counterclockwise relative to the lever 30 (FIG. 7), and thus may force and disengage the catch 43 of the latch device 40 from the protrusion 14 of the lever 10, and thus to selectively disengage or separate the levers 10, 30 from each other, the catch 43 of the latch device 40 may also be forced to engage with either of the lock notches 15, 16 of the protrusion 14 of the lever 10 (FIG. 8) when the user depresses the rear portion of the knob 42 onto or against the spring member 39.

Accordingly, the fish handling pliers in accordance with the present invention includes a latch or positioning device for anchoring or positioning two levers together or for biasing the levers away from each other.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fish handling pliers comprising:
a first lever and a second lever including a middle portion pivotally coupled together with a pivot axle, and each including a jaw member at one end thereof, and each including a handle member at the other end thereof,
said first lever including a protrusion extended from said middle portion of said first lever, and said protrusion including a lock notch formed in said protrusion, and said second lever including a channel formed in said middle portion of said second lever,
a latch device engaged through said channel of said second lever and pivotally coupled to said second lever with a pivot shaft for allowing said latch device to be pivoted relative to said second lever, and said latch device including a knob provided on top thereof, and including a catch provided thereon for engaging with said lock notch of said second lever and for latching said first and said second levers together, and
a spring biasing means for biasing said latch device to pivot relative to said second lever.

2. The fish handling pliers as claimed in claim 1, wherein said first lever includes at least one second lock notch formed in said protrusion for selectively engaging with said catch of said latch device.

3. The fish handling pliers as claimed in claim 1, wherein said second lever includes a cavity formed therein, and said spring biasing means includes a spring member engaged in said cavity of said second lever and engaged with said knob of said latch device for forcing said catch of said latch device to engage with said lock notch of said protrusion of said first lever.

4. The fish handling pliers as claimed in claim 1, wherein said second lever includes a cavity formed therein, and said spring biasing means includes a spring member engaged in said cavity of said second lever and engaged with said knob of said latch device for disengaging said catch of said latch device from said protrusion of said first lever.
